(19) United States
(12) Patent Application Publication
(10) Pub. No.: US 2008/0226777 A1
(43) Pub. Date: Sep. 18, 2008

(54) Frozen alcoholic cocktail

(75) Inventors: Jody Helfend, Calabasas, CA (US); Gary Winkler, Irvine, CA (US)

Correspondence Address: WILLIAM G. LANE;WILLIAM G. LANE, INC., PC, 16485 LAGUNA CANYON RD, SUITE 250, IRVINE, CA, 92618, US

(73) Assignee: Beach Club Ices, LLC

(21) Appl. No.: 12/152,475

(22) Filed: May 15, 2008

Related U.S. Application Data
(63) Continuation of application No. 11/604,456, filed on Nov. 27, 2006.
(60) Provisional application No. 60/741,527, filed on Dec. 1, 2005.

(51) Int. Cl. C12G 3/06

(52) U.S. Cl. 426/134; 426/592

(57) ABSTRACT

A cocktail composition adapted to be frozen and maintained in the frozen state at a temperature below 0° C. comprising from about 10% to about 25% by volume alcoholic spirit; from about 10% to about 50% by volume cocktail mix; from about 80% to about 25% by volume water to make 100%; and from about 1 to about 5 grams of guar gum and/or xanthan gum per 100 fluid ounces of the mix of alcoholic spirit, cocktail mix and water.

This application in a continuation application of U.S. application Ser. No. 11/604,456 filed on Nov. 27, 2006 and claims the benefit of U.S. application Ser. No. 11/604,456, and the U.S. Provisional Application No. 60/741,527, filed on Dec. 1, 2005 which pending U.S. application Ser. No. 11/604,456 filed on Nov. 27, 2006 claimed the benefit of.

This application incorporates by reference the entire specification and disclosure of U.S. Provisional Application No. 60/741,527 filed on Dec. 1, 2005 and U.S. application Ser. No. 11/604,456 filed on Nov. 27, 2006.

### FIELD OF THE INVENTION

The present invention is directed to frozen alcoholic cocktails. In particular, to a frozen cocktail mounted on a stick.

### BACKGROUND OF THE INVENTION

Frozen alcoholic beverages are challenging to prepare, store and transport. Several problems interfere with the successful manufacture and utilization of frozen cocktail beverages. Beverages are normally frozen in molds. The portion of the beverage closest to the mold walls freeze first because the mold walls are subject to freezing temperatures to freeze the beverage. The first problem is associated with segregation during freezing. During the freezing step, water freezes first near the mold walls which concentrates the alcohol and the flavoring components into the unfrozen liquid farthest from the mold walls which freezes as the final step. Thus, the frozen cocktail beverage is not uniform and only a portion of the frozen cocktail beverage contains the alcohol and the flavoring, whereas the rest of the frozen cocktail beverage, the outer portion, is primarily made up of water. This gives a very unsatisfactory product.

The second problem associated with a frozen cocktail or cocktail beverage is the fact that when a frozen cocktail beverage is exposed to ambient temperature, the alcohol separates out of the frozen cocktail beverage and migrates to the surface of the frozen cocktail beverage where it bleeds out. Alcohol, having a higher vapor pressure at room temperature than water, evaporates off much easier than the water. The result is that the exposed surface of the frozen cocktail beverage when exposed to ambient temperature contains most of the alcohol which drips off or is evaporated, whereas, when a third of the frozen beverage has been consumed, the remaining portion of the frozen cocktail beverage is relatively free of alcohol.

A third problem relates to the convenience of use. Ideally, the frozen cocktail would be mounted on a stick so the frozen cocktail can be held in the hand. This permits the frozen cocktail to be licked, sucked, and/or eaten like an ice cream bar. This avoids the need for a cup or container or special packing for the frozen Unfortunately it is not easy to freeze an alcoholic cocktail on a stick and form a ‘good bond’ between the frozen cocktail and the stick. if the alcohol separates from the frozen material or if the frozen cocktail is not frozen solid, the frozen cocktail can separate from the stick and fall off the stick. This is a major problem because as stated above the water freezes first on the outside next to the mold walls and the alcohol and other ingredients freeze last toward the middle of the frozen cocktail. Thus the middle portion of the frozen cocktail is high in the cocktail ingredients and the outside portion is substantially water. The middle enriched frozen composition thaws easier than the water portion and does not freeze into a stable solid as the water portion. Thus the bond between the stick and the middle enriched frozen composition is not as secure as is desirable.

These problems have not been overcome until now.

It is an object of the present invention to provide a way of freezing a cocktail beverage to form a frozen cocktail wherein the composition of the frozen cocktail is relatively uniform throughout the frozen cocktail.

It is a further object of the present invention to prevent separation of the alcohol from the frozen cocktail beverage when the frozen cocktail beverage is exposed to ambient temperature so that the alcohol concentration throughout the frozen cocktail or cocktail beverage will remain relatively uniform during consumption.

An additional object of the present invention is to provide a frozen alcoholic cocktail on a stick which can be consumed on the stick.

It is still another object of the present invention to provide a frozen alcoholic cocktail that is relatively stable when exposed to ambient temperature so that the alcohol does not rapidly bleed from the frozen cocktail.

### SUMMARY OF INVENTION

The present invention is directed to a frozen cocktail containing spirits, such as Rum, Tequila, Vodka, Bourbon, Scotch, or the like; a cocktail mix, such as Margarita Mix, Daiquiri Mix, Hot Buttered Rum Mix, Tom and Jerry Mix, Eggnog Mix, and the like; water; and guar gum or xanthan gum or a combination thereof. Optionally, the frozen cocktail or cocktail beverage may contain coloring agent, additional flavoring agents, such as cherries, olives, slices of lemon rind, lime rind, and/or orange rind, pineapple pieces, and other fruit pieces. Preferably, the frozen cocktail is mounted on a stick.

### DETAILED DESCRIPTION OF THE INVENTION

Known cocktail mixes, such as Margarita Mixes, Daiquiri Mixes, Eggnog Mixes, etc., can be employed in the present invention. These mixes are normally water based. In some cocktail mixes, all the ingredients are fully soluble in the water base, whereas other mixes contain some insoluble matter and/or emulsions of water soluble materials with water insoluble materials. Most cocktail mixes contain sugar and flavoring. The cocktail mixes also frequently contain coloring agents.

The use of guar gum and/or xanthan gum in a mixture is found to be essential for the practice of the present invention. Preferably, xanthan gum is also added.

A typical frozen cocktail composition will contain from about 10% to about 25% of an alcoholic spirit such as Rum or Tequila, 10% to 50% of a cocktail mix, about 1 to about 5 grams of guar gum and/or xanthan gum per 100 fluid ounces of the final cocktail, and the balance being water (25% to about 80%). Preferably, water and the gum[s] are mixed together prior to introducing the alcoholic spirit. The cocktail mix is preferably introduced and mixed in last. The resulting cocktail composition is preferably maintained in an agitated state to ensure uniform and complete mixing. The cocktail composition is preferably frozen in less than five minutes, preferably less than two minutes, and most preferably in about one minute.

The quick freezing can be achieved by introducing the cocktail composition into a mold having conductive walls, such as aluminum walls, copper walls or silver walls. The outside of the cavity or mold is subject to a temperature of less than 0° C., preferably less than about −25° C., and most preferably at least −30° C. A frozen cocktail that is six inches or less in height with a cross section of less than eight square inches can be frozen in about a minute when the cavity or mold is subject to a temperature of −30° C. When the frozen cocktail is to be secured to a stick, such as a stick used for frozen ice cream bars, the stick is inserted into the middle of the cavity with two or three inches of the stick sticking out of the cavity about half way through the freezing process. The stick can be made of wood, plastic, or paper cardboard material. The cross section of the stick can be circular, square, or rectangular. A flat wood stick is preferred. By this time, the cocktail composition has obtained a semi-frozen state whereby the stick can be embedded into the semi-frozen cocktail. The semi-frozen cocktail composition has a consistency like a thick mush at this point and the stick is easily positioned in the semi-frozen cocktail and remains in position. The stick is inserted about half way into the cocktail. When the cocktail or beverage is completely frozen, the frozen cocktail is pulled from the cavity when it is on a stick or the cavity is turned upside down and the frozen cocktail slips out of the cavity by the weight of gravity. The rapid freezing helps prevent or minimize separation of the alcohol and cocktail mix from the water base as the cocktail composition is frozen.

All percentages stated herein are percentage by volume. Ounces are fluid ounces.

The alcoholic spirit will contain between about 37% and about 50% ethanol.

The frozen cocktail can be maintained at a frozen state below 0° C. Preferably, the frozen cocktail is maintained in a frozen state at a temperature no higher than −10° C. Most preferably, the frozen cocktail is stored and transported at a temperature of −20° C. or less.

### EXAMPLES 1A-1H

Formulations

| | | |
|---|---|---|
| Margarita I | A. | 16% Tequila |
| | B. | 26% Margarita Mix |
| | C. | 58% Water |
| | D. | 3 grams Guar Gum per 100 oz of A, B, and C. |
| Strawberry | E. | 16% Rum |
| Daiquiri I | F. | 26% Strawberry Daiquiri Mix |
| | G. | 58% Water |
| | H. | 3 grams Guar Gum per 100 oz of E, F, and G. |
| Margarita II | I. | 15% Tequila |
| | J. | 26% Margarita Mix |
| | K. | 59% Water |
| | L. | 3 grams Guar Gum per 100 oz of I, J, and K. |
| Strawberry | M. | 15% Rum |
| Daiquiri II | N. | 26% Strawberry Daiquiri Mix |
| | O. | 59% Water |
| | P. | 3 grams Guar Gum per 100 oz of M, N, and O. |
| Margarita III | Q. | 10% Tequila |
| | R. | 50% Margarita Mix |
| | S. | 40% Water |
| | T. | 1 gram Xanthan Gum and |
| | | 2 grams Guar Gum per 100 oz of Q, R, and S. |
| Margarita IV | U. | 25% Tequila |
| | V. | 10% Margarita Mix |
| | W. | 65% Water |
| | X. | 5 grams Xanthan Gum per 100 oz of U, V, and W. |
| Banana | Y. | 12.5% Rum |
| Daiquiri | Z. | 30% Banana Daiquiri Mix |
| | AA. | 47.5% Water |
| | BB. | 5 grams Guar Gum per 100 oz of Y, Z, and AA. |
| Daiquiri | CC. | 10% Rum |
| | DD. | 10% Daiquiri Mix |
| | EE. | 80% Water |
| | FF. | 1 gram Guar Gum per 100 oz of CC, DD, and EE. |

### EXAMPLE 2

### Method

Mix 101.5 grams of guar gum with 58 liters of water until fully dissolved to form an aqueous guar gum solution. Add 16 liters of Tequila into the aqueous guar gum solution and mix to form a uniform aqueous Tequila guar gum composition. Add 26 liters of Margarita Mix to the aqueous Tequila guar gum composition and stir to form a uniform Margarita cocktail composition. Pour the composition into conductive molds, 8 fluid ounces (about 237 ml.). Subject the molds to a −30° C. solution without contaminating the cocktail mix. Insert 5-inch (about 12.5 cm) flat wooden sticks half-way into the Margarita cocktail composition when it is cooled to a semi-frozen state having the consistency of thick mush. Continue to subject the molds to the −30° C. solution until the Margarita cocktail mix has frozen solid. Remove the mold from the −30° C. solution. Remove the frozen cocktail from the mold. Package the frozen cocktail in a sealed fluid impervious envelope and store the frozen cocktail at −20° C.

1. A cocktail composition adapted to be maintained in a frozen state at a temperature below 0° C. comprising from about 10% to about 25% by volume alcoholic spirit; from about 10% to about 50% by volume cocktail mix; from about 80% to about 25% by volume water to make 100%; and from about 1 to about 5 grams of guar gum and/or xanthan gum per 100 fluid ounces of the mix of alcoholic spirit, cocktail mix and water.

2. The cocktail composition according to claim 1 wherein the frozen cocktail composition is maintained in a frozen state at a temperature below −20° C. and the alcoholic spirit is Tequila, and the cocktail mix is a Margarita Mix.

3. The cocktail composition according to claim 1 wherein the frozen cocktail composition is maintained in a frozen state at a temperature below −20° C. and the alcoholic spirit is Rum, and the cocktail mix is a Strawberry Daiquiri Mix.

4. The cocktail mix according to claim 1 wherein the frozen cocktail composition comprises about 15% by volume alcoholic spirit, about 26% by volume cocktail mix, about 59% by volume water, and about 3 grams of guar gum per 100 fluid ounces of the mix of alcoholic spirits, cocktail mix and water.

5. The cocktail mix according to claim 4 wherein the alcoholic spirit is Tequila and the cocktail mix is Margarita Mix.

6. The cocktail mix according to claim 4 wherein the alcoholic spirit is Rum and the cocktail mix is Strawberry Daiquiri Mix.

7. A frozen cocktail composition mounted on a stick comprising a frozen body of a cocktail composition frozen around a wooden stick, the cocktail composition comprising about 15% by volume alcoholic spirit; about 26% by volume cocktail mix; about 59% by volume water to make 100%; and about 3 grams of guar gum and/or xanthan gum per 100 fluid ounces of the mix of alcoholic spirit, cocktail mix and water.

8. The cocktail mix according to claim 4 wherein the alcoholic spirit is selected from the group consisting of Tequila and Rum and the cocktail mix is selected from the group consisting of Margarita Mix and Strawberry Daiquiri Mix, respectively.

9. A method of making a frozen alcoholic cocktail comprising the steps of:
(a) mixing guar gum and water to form aqueous gum mix;
(b) mixing alcoholic spirit into the aqueous gum mix to form an aqueous alcoholic gum mix;
(c) mixing a cocktail mix into the aqueous alcoholic gum mix to form a cocktail composition;
(d) introducing the cocktail composition into a mold having conductive walls;
(e) subjecting the mold with the cocktail composition to a temperature of at least −30° C. to freeze the cocktail composition in the mold within about one minute.
(f) inserting a flat wooden stick into the cocktail composition when it reaches a consistency of a thick mush; and
(g) continuing to subject the mold with the cocktail composition to a temperature of at least −30° C. to freeze the cocktail composition solid.

10. The method according to claim 9 wherein the cocktail composition is compounded in accordance with the following ratio: from about 10% to about 25% by volume alcoholic spirit; from about 10% to about 50% by volume cocktail mix; from about 80% to about 25% by volume water to make 100%, and from about 1 to about 5 grams of guar gum and/or xanthan per 100 fluid ounces of the mix of alcoholic spirits, cocktail mix and water.
